(19) United States
(12) Patent Application Publication
(10) Pub. No.: US 2023/0079282 A1
(43) Pub. Date: Mar. 16, 2023

(54) Seat Positioning Systems

(71) Applicant: Apple Inc., Cupertino, CA (US)

(72) Inventors: Nathaniel J. Dennis, Saratoga, CA (US); Adam J. Golman, Glen Allen, VA (US)

(21) Appl. No.: 17/879,109

(22) Filed: Aug. 2, 2022

Related U.S. Application Data
(60) Provisional application No. 63/244,087, filed on Sep. 14, 2021.

(51) Int. Cl. B60N 2/427; B60N 2/00

(52) U.S. Cl. CPC B60N 2/42718; B60N 2/002

(57) ABSTRACT

A positioning system includes a deflection surface disposed within a seat, configured to support an occupant in the seat, and movable in response to motion of the occupant. The positioning system also includes a lock movable between an unlocked position in which the lock permits motion of the deflection surface relative to motion of the occupant and a locked position in which the lock restrains motion of the deflection surface relative to motion of the occupant. The lock is configured to move from the unlocked position to the locked position in response to receiving a signal from a controller, the signal including information indicative of a vehicle event.

### CROSS-REFERENCE TO RELATED APPLICATION(S)

This application claims the benefit of U.S. Provisional Patent Application No. 63/244,087 filed on Sep. 14, 2021, the content of which is hereby incorporated by reference in its entirety for all purposes.

### TECHNICAL FIELD

This disclosure relates generally to positioning systems and specifically to devices configured to control motion of an occupant with respect to a seat pan within a seating system.

### BACKGROUND

A vehicle cabin may include modular interior elements such as seat systems that can be arranged into a configuration consistent with the vehicle cabin serving as a mobile office, a living room, or a relaxation space. In such seating arrangements, occupants may spend time with seat backs partially or full reclined, that is, with recline angles larger than those typical to more conventional upright seating configurations. Occupants that are secured to seats with higher angles of rotation between the seat pan and the seat back, that is, in deeper recline, can have an increased risk of submarining compared to more upright occupants. Submarining, that is, a tendency of the occupant to slide between a safety restraint and a seat pan may occur in some types of vehicle events, such as under high rates of deceleration or during a collision.

### SUMMARY

In a first aspect, a positioning system includes a deflection surface disposed within a seat, configured to support an occupant in the seat, and movable in response to motion of the occupant. The positioning system includes a lock movable between an unlocked position in which the lock permits motion of the deflection surface relative to motion of the occupant and a locked position in which the lock restrains motion of the deflection surface relative to motion of the occupant. The lock is configured to move from the unlocked position to the locked position in response to receiving a signal from a controller, the signal including information indicative of a vehicle event.

In the first aspect, the positioning system may include a tensioner coupled to the deflection surface and the seat, the tensioner configured to control motion of the deflection surface with respect to the seat. The tensioner may comprise a compressible portion configured to deform above a predetermined load threshold. The lock may be configured to restrict deformation of the compressible portion in the locked position. The lock may include a pretensioner configured to irreversibly restrain motion of the deflection surface in the locked position. The deflection surface may comprise flexible straps, a flexible panel, a rigid panel, or combinations thereof. The positioning system may include a sleeve disposed within the seat and configured to isolate the deflection surface from other components within the seat, the deflection surface movable within the sleeve. The lock may be configured to move from the unlocked position to the locked position in response to receiving information indicative of a recline angle of a seat back of the seat relative to a seat pan of the seat being above a recline threshold. The lock may be configured to move from the locked position to the unlocked position in response to receiving information indicative of the recline angle being below the recline threshold. The recline threshold may be greater than or equal to 45 degrees. Any of the features described in this paragraph may be used alone or in combination for the first aspect.

In a second aspect, a positioning system includes a seat including a seat back positioned in relation to a seat pan at a recline angle, a deflection surface disposed within the seat pan and movable in response to motion of an occupant in the seat, a tensioner configured to control motion of the deflection surface with respect to the seat pan, and a lock configured to restrain motion of the deflection surface relative to the tensioner. The lock is configured to restrict motion of the deflection surface relative to the tensioner based on receipt of information indicative of a vehicle event and based on receipt of information indicative of a recline angle being above a recline threshold.

In the second aspect, the positioning system may include an anti-submarining restraint disposed within the seat pan, and the tensioner and the lock are disposed within the anti-submarining restraint. The tensioner may include a retractor and a pulley configured to control tension in the deflection surface, a spool configured to control tension in the deflection surface, or a combination thereof. 17. The deflection surface may comprise a flexible panel. The tensioner may comprise a compressible portion configured to deform above a predetermined load threshold to control motion of the deflection surface. The lock may be configured to restrict deformation of the compressible portion, and wherein the deflection surface comprises a rigid panel supported on the compressible portion. Any of the features described in this paragraph may be used alone or in combination for the second aspect.

In a third aspect, a method of controlling motion of an occupant in a seat pan includes receiving, at a controller, information indicative of an imminent vehicle event and sending a command, from the controller, to a lock to cause the lock to move from an unlocked position in which the lock permits motion of a deflection surface to a locked position in which the lock restrains motion of the deflection surface based on the information indicative of the imminent vehicle event. The deflection surface is disposed within a seat pan and supports an occupant in the seat pan.

In the third aspect, the seat pan may include a tensioner coupled to the deflection surface, the tensioner controlling motion of the deflection surface with respect to the seat pan. The tensioner may include a compressible portion deforming above a predetermined load threshold to control motion of the deflection surface. The method may include receiving, at the controller, information indicative of a recline angle between the seat pan and a seat back being above a recline threshold and sending a command, from the controller, to the lock to cause the lock to move from the unlocked position to the locked position based on the information indicative of the recline angle being above the recline threshold. Any of the features described in this paragraph may be used alone or in combination for the third aspect.

### BRIEF DESCRIPTION OF THE DRAWINGS

FIGS. 1A and 1B show a seat and a restraint for use with a vehicle.

FIGS. 2A, 2B, and 2C show a positioning system for use with the seat of FIGS. 1A and 1B.

FIGS. 3A, 3B, and 3C show another positioning system for use with the seat of FIGS. 1A and 1B.

FIGS. 4A and 4B show another positioning system for use with the seat of FIGS. 1A and 1B.

FIG. 5 is an illustration of a hardware configuration for a controller.

### DETAILED DESCRIPTION

Positioning systems described herein provide seated occupants flexibility in seating position, such as seating positions with deeper recline of a seat back in respect to a seat pan, without sacrificing comfort during normal driving conditions. The positioning systems include deflection surfaces, such as straps, panels, or cables, disposed within a seat pan, such as between or below foam layers or a seat cover, and controllable using tensioners and locks that prioritize comfort during normal driving conditions and safety during predetermined vehicle events such as rapid deceleration, activation of anti-lock braking, or before or during a vehicle collision. The positioning systems described here can work with other safety systems, such as with lap belts, shoulder belts, and airbags to unobtrusively reposition or hold a position of a seated occupant based on, for example, a recline angle of a seat back in respect to a seat pan, a detected vehicle event, or both.

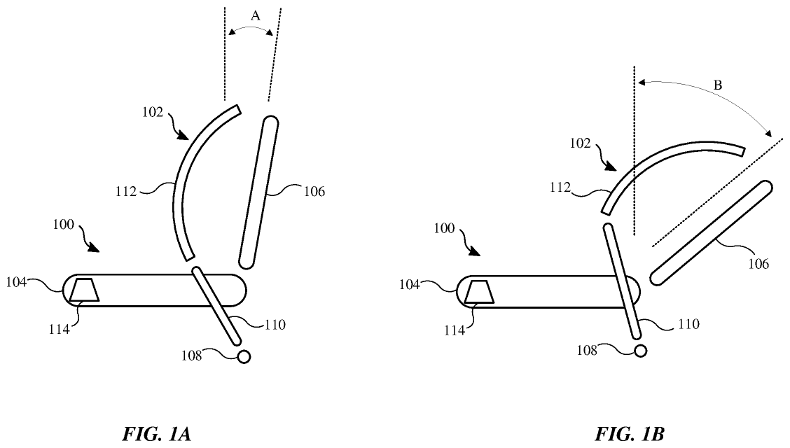

FIGS. 1A and 1B show a seat 100 and a restraint 102 for use with a vehicle (not shown). The seat 100 includes a seat pan 104 and a seat back 106. The restraint 102 includes a restraint anchor 108, a lap portion 110, and a shoulder portion 112. In some embodiments, the seat pan 104 may include an anti-submarining restraint 114.

In FIG. 1A, the seat back 106 is rotated away from or reclined with respect to the seat pan 104 and with respect to a vertical, up-down, or z-direction at a recline angle A as shown. The recline angle A is consistent with an upright position for an occupant secured to the seat 100 and can range, for example, from 0 degrees to 30 degrees, from 10 degrees to 40 degrees, etc. In FIG. 1B, the seat back 106 is reclined with respect to the seat pan 104 and the vertical, up-down, or z-direction at a recline angle B as shown. The recline angle B is consistent with a deeper recline of an occupant secured to the seat 100 and can have values, for example, from 30 to 90 degrees, from 40 to 70 degrees, from 45 to 60 degrees, greater than or equal to 45 degrees, greater than or equal to 60 degrees, or greater than or equal to 75 degrees.

The restraint 102 is designed to secure an occupant to the seat 100. The restraint anchor 108 can secure the restraint 102 to the seat 100 or to another structure (not shown) within the vehicle. The restraint anchor 108 can also provide directional guidance to position the restraint 102 against the occupant's body. The restraint 102 can include additional anchors (not shown), buckles (not shown), or other mechanism to secure and release the restraint 102. The restraint 102 may also include retractors or pretensioners (not shown) that control payout of the portions 110, 112 of the restraint 102 with respect to the restraint anchor 108 during various vehicle events such as rapid deceleration, activation of anti-lock braking, or a vehicle collision.

The anti-submarining restraint 114 is designed to retain an occupant within the seat pan 104 during various vehicle events. The anti-submarining restraint 114 can be a crossbar, a support, a brace, a link, a channel, a ramp, or a combination thereof. The anti-submarining restraint 114 is designed to guide a pelvis of an occupant upward in the vertical, up-down, or z-direction during a vehicle event such as a rapid deceleration, anti-lock braking, or before or during a vehicle collision, working in conjunction with the restraint 102 to secure an occupant (not shown) to the seat 100. In other words, retractors or pretensioners (not shown) may secure the lap portion 110 of the restraint 102 and control or limit up-down or z-direction motion while the anti-submarining restraint 114 controls or limits fore-aft or x-direction motion of a restrained occupant during certain vehicle events when the seat 100 is positioned or reclined as shown in FIG. 1A.

If the seat 100 is positioned or reclined as shown in FIG. 1B, the lap portion 110 of the restraint 102 may become elongated or repositioned as shown. When repositioned or elongated, retractors or pretensioners (not shown) may be less effective in rapidly securing an occupant to the seat pan 104 of the seat 100. The anti-submarining restraint 114 in FIG. 1B may also have a decreased ability to control fore-aft or x-direction motion of the restrained occupant as compared to FIG. 1A since the restraint 102 is not positioning the occupant efficiently or accurately with respect to the anti-submarining restraint 114.

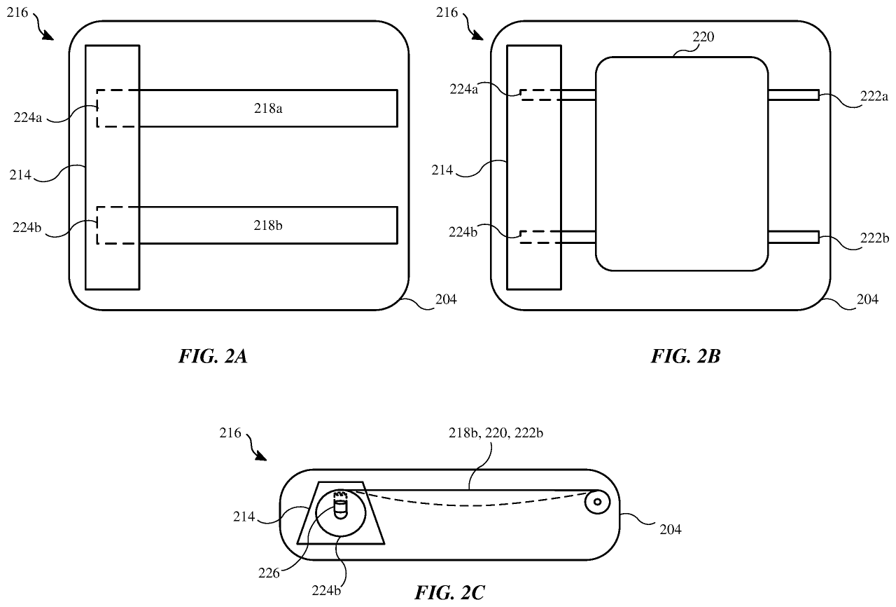

FIGS. 2A, 2B, and 2C show examples of a positioning system 216 for use with the seat 100 of FIGS. 1A and 1B. The positioning system 216 is shown as disposed within a seat pan 204 similar to the seat pan 104 of FIGS. 1A and 1B. In FIGS. 2A and 2B, the seat pan 204 is shown from a top sectional or cutaway view. In FIG. 2C, the seat pan 204 is shown from a side sectional or cutaway view. FIGS. 2A and 2B show alternative constructions for some of the components within the positioning system 216.

The positioning system 216 includes a deflection surface disposed within the seat pan 204 that is configured to support an occupant in the seat, that is, on the seat pan 204. In the example of FIG. 2A, the deflection surface includes straps 218a,b extending from a front of the seat pan 204 to a back of the seat pan 204. The straps 218a,b may be flexible, formed from seat-belt webbing material, woven material, high performance fabric, or other material designed to withstand both tensile loads and normal loads. The straps 218a,b may be positioned near a top of seat pan 204, close to a seated occupant. The straps 218a,b may be spaced apart and positioned within the seat pan 204 in order align, for example, with pelvic bones of a seated occupant to support both a narrower width of the straps 218a,b and a limited amount of packaging space required for the positioning system 216 in the seat pan 204.

In the example of FIG. 2B, the deflection surface includes a panel 220. The panel 220 may be rigid or flexible. For example, the panel 220 may be formed by materials such as seat-belt webbing material, thinner-gauged steel, aluminum, alloy, composite, or other rigid or deformable materials. In cases where the panel 220 is generally flexible, the panel 220 may be positioned near a top of seat pan 204, close to a seated occupant. In cases where the panel 220 is generally rigid, deformability may be provided by perforations, holes, etc. (not shown) that modify elongation and lower yield properties of the panel 220. In the example of FIG. 2B, the panel 220 is coupled to ropes or cables 222a,b, thus the deflection surface in FIG. 2B includes both the panel 220 and the cables 222a,b. The panel 220 may be positioned within the seat pan 204 in a manner that aligns with the pelvic bones of a seated occupant whereas the cables 222a,b may be positioned to avoid direct loading from the seated occupant for both comfort and packaging efficiency.

The positioning system 216 of FIGS. 2A to 2C includes tensioners 224a,b coupled to the deflection surfaces (e.g., the straps 218a,b, the panel 220, or the cables 222a,b) and the seat pan 204. The tensioners 224a,b are configured to control motion of the deflection surfaces. For example, the tensioners 224a,b may include a retractor, an actuator, a spool, a torsion bar, a pulley, a ratchet, a pawl, an inertial lock, or a combination thereof configured to control tension in the respective deflection surface, such as by pulling taut or loosening to provide slack. Though two tensioners 224a,b are shown, fewer or additional are also possible. As best shown in FIG. 2C, the tensioner 224b includes a spool around which at least a portion of the deflection surface (e.g., the strap 218b or the cable 222b and the coupled panel 220) may be wound and unwound such that the deflection surface includes slack as shown in dashed line or is pulled taut as shown in solid line. Rotation of the deflection surface (e.g., the strap 218b or the cable 222b) may be limited, such as half a circumference, one winding, or two windings around the spool of the tensioner 224b.

The positioning system 216 of FIGS. 2A to 2C includes an anti-submarining restraint 214 disposed within the seat pan 204. In this example, the tensioner 224a,b is disposed within the anti-submarining restraint 214, for example, to take advantage of available packaging space within the anti-submarining restraint 214. The anti-submarining restraint 214 is similar to the anti-submarining restraint 114 of FIGS. 1A and 1B and is configured to block forward motion of an occupant in the seat pan 204 during a vehicle event while at the same time raising a position of the occupant so that the occupant is better secured in the seat pan 204 by a restraint such as the restraint 102 of FIGS. 1A and 1B. As the anti-submarining restraint 214 and the deflection surface (e.g., the straps 218a,b, the panel 220, and/or the cables 222a,b) are both designed to control an up-down or Z-direction position of an occupant in the seat pan 204 before or during a vehicle event, a size of the anti-

may be reduced as compared to the anti-submarining restraint 114 of FIGS. 1A and 1B, reducing weight and improving occupant comfort in the seat pan 204.

As best shown in FIG. 2C, the positioning system 216 includes a lock 226. The lock 226 is disposed within the anti-submarining restraint 214, and in this example, within the tensioner 224b. The lock 226 is movable between an unlocked position, shown in solid lines, in which the lock 226 permits motion of the deflection surface relative to the tensioner 224b, and a locked position, shown in dotted lines, in which the lock 226 restrains motion of the deflection surface relative to the tensioner 224b. The lock 226 may be configured to move back and forth between the unlocked position and the locked position based on commands, for example, from a controller. In the example shown in FIG. 2C, actuation of the lock 226 has a clamp-like effect, compressing the deflection surface (e.g., the strap 218b or the cable 222b) against a body of either a spool portion of the tensioner 224b or a rigid portion of the anti-submarining restraint 214.

Actuation of the lock 226 may be reversible. In reversible systems, the lock 226 can include electromechanical components such as actuators, pistons, clamps, cams, or other components sufficient to reversibly hold a position of the deflection surface (e.g., the strap 218b or the cable 222b) relative to the tensioner 224b. In other embodiments, actuation of the lock 226 may be irreversible, that is, moving from the unlocked position to the locked position may occur only once. In irreversible systems, the lock 226 can include mechanical components such as a mechanical lock that engages above a predetermined acceleration threshold or pyrotechnic components such as a pretensioner that actuates in response to sensor information indicative of a vehicle event. Actuation of the pretensioner can irreversibly restrain motion of the deflection surface in the locked position while engagement of the mechanical lock may be reversible. In some examples, actuation of the lock 226 can be both reversible in a first stage and irreversible in a second stage. For example, the lock 226 may include both an electromechanical clamping mechanism for the first stage, such as when rapid deceleration or anti-lock braking is detected, and a pyrotechnic pretensioner for the second stage, such as when a vehicle collision is detected.

In operation of the positioning system 216 shown in FIGS. 2A to 2C, a controller (not shown) can receive information indicative of a vehicle event, such as an imminent collision, anti-lock braking, or rapid deceleration. The controller may also receive information indicative of a recline angle of a seat including the seat pan 204 being above a recline threshold, such as above a 45, 60, or 75 degree threshold. The information can be received from various sensors (not shown) that communicate information to the controller. For example, the sensors can include sensors configured to capture information from an external environment outside of the vehicle cabin. External-sensing sensors can include technologies such as radar, LIDAR, imaging, infrared, or other technologies configured to detect ongoing, potential, or imminent vehicle events such as collisions, anti-lock braking, or rapid deceleration and provide information to the controller to allow a determination of timing of the vehicle event. The sensors can also include sensors internal to the vehicle such as weight sensors, buckle switch sensors, internal cameras, seat position sensors, imaging sensors, etc. that can provide information to the controller.

The controller can send a command, for example, to the lock 226, that causes the lock 226 to restrict motion of the deflection surface (e.g., the strap 218b or the cable 222b) based on the information indicative of the vehicle event, the information indicative of the recline angle being above the recline threshold, or both. The command sent to the lock 226 may cause the lock 226 to move from the unlocked position shown in solid lines in FIG. 2C to the locked position shown in dotted lines in FIG. 2C. In cases where the lock 226 is caused to move from the unlocked position to the locked position based only on the information indicative of the recline angle of the seat including the seat pan 204 being above the recline threshold, the lock 226 may also be caused to move from the locked position to the unlocked position based on additional information, e.g., from the sensors, indicative of the recline angle of the seat including the seat pan 204 moving below the recline threshold, such as below 45, 60, or 75 degrees.

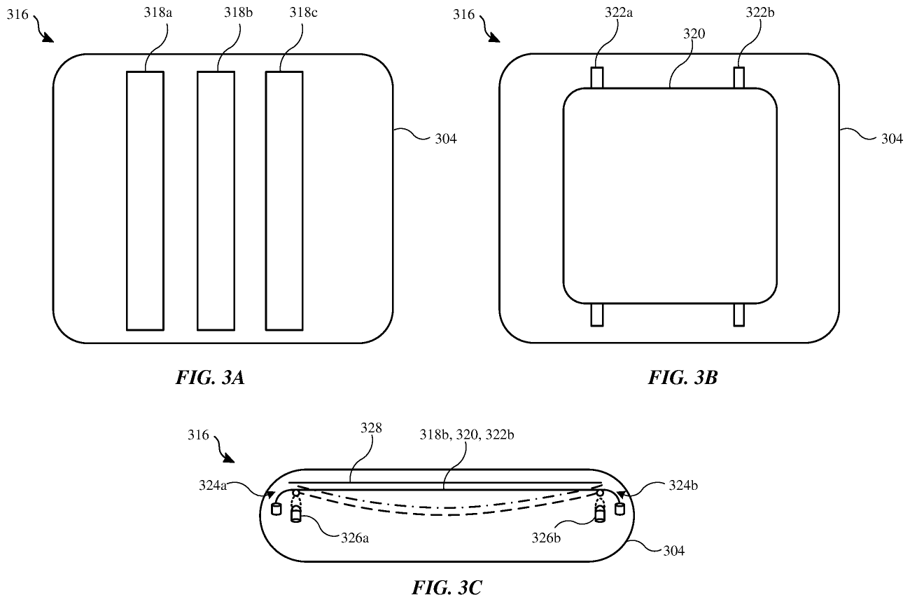

FIGS. 3A, 3B, and 3C show examples of another positioning system 316 for use with the seat 100 of FIGS. 1A and 1B. The positioning system 316 is shown as disposed within a seat pan 304 similar to the seat pans 104, 204 of FIGS. 1A to 2C. In FIGS. 3A and 3B, the seat pan 304 is shown from a top sectional or cutaway view. In FIG. 3C, the seat pan 304 is shown from a front (or back) sectional or cutaway view. FIGS. 3A and 3B show alternative constructions for some of the components within the positioning system 316.

The positioning system 316 includes a deflection surface disposed within the seat pan 304 that is configured to support an occupant in the seat, that is, on the seat pan 304. In the example of FIG. 3A, the deflection surface includes straps 318a,b,c extending from one side of the seat pan 304 to another side of the seat pan 304. The straps 318a,b may be flexible, formed from seat-belt webbing material, woven material, high performance fabric, or other material designed to withstand both tensile loads and normal loads. The straps 318a,b,c may be spaced apart and positioned within the seat pan 304 in order align, for example, with weight distributions of 5^{th} to 95^{th} percentile sizes of seated occupants. In this way, the straps 318a,b,c may be generally central within the seat pan 304 as shown.

In the example of FIG. 3B, the deflection surface includes a panel 320. The panel 320 may be rigid or flexible. For example, the panel 320 may be formed by materials such as seat-belt webbing material, thinner-gauged steel, aluminum, alloy, composite, or other rigid or deformable materials. In cases where the panel 320 is generally rigid, deformability may be provided by perforations, holes, etc. (not shown) that modify elongation and lower yield properties of the panel 320. In the example of FIG. 3B, the panel 320 is coupled to wires, ropes, or cables 322a,b, thus the deflection surface in FIG. 3B includes both the panel 320 and the cables 322a,b. The panel 320 may be positioned within the seat pan 304 in a manner that aligns with weight distributions of 5^{th} to 95^{th} percentile sizes of seated occupants whereas the cables 322a,b may be positioned to avoid direct loading from 5^{th} to 95^{th} percentile sizes of seated occupants to allow for both comfort and packaging efficiency.

As shown in FIG. 3C, the positioning system 316 includes tensioners 324a,b configured to control motion of the deflection surfaces (e.g., the strap 318b, the panel 320, or the cable 322b) with respect to the seat pan 304. For example, each of the tensioners 324a,b may include a retractor, an actuator, a spool, a torsion bar, a pulley, or a combination thereof used to control tension in the respective deflection surface. Though two tensioners 324a,b are shown, one per side of the seat pan 304, additional or fewer are possible. In the example of FIG. 3C, the tensioners 324a,b include both a retractor that can apply and release tension and a spool or pulley around which at least a portion of the deflection surface (e.g., the strap 318b or the cable 322b) may be wound and unwound such that the deflection surface may include slack as shown in dashed line or be pulled taut as shown in solid line.

As shown in FIG. 3C, the positioning system 316 includes a sleeve 328 disposed within the seat pan 304 and configured to isolate the deflection surface (e.g., the strap 318b, the panel 320, or the cable 322b) from other components (not shown) within the seat pan 304. The sleeve 328 is configured to avoid binding, catching, or friction between the deflection surface and the other components within the seat pan 304 during motion of the deflection surface. In other words, the deflection surface is movable, e.g., slidable, within the sleeve 328. The sleeve 328 is also movable with the deflection surface, e.g., as shown with the dashed-dotted line for the sleeve 328 and the dashed line for the deflection surface. The sleeve 328 can be configured to allow relative motion of the deflection surface in respect to materials such as foam layers (not shown) within the seat pan 304 or a cover (not shown) of the seat pan 304 that surrounds the foam layers and the deflection surface.

As shown in FIG. 3C, the positioning system 316 includes a pair of locks 326a,b. The locks 326a,b may be part of, coupled to, or act against the respective tensioners 324a,b as shown. The locks 326a,b are movable between unlocked positions, shown in solid lines, in which the locks 326a,b permit motion of the deflection surface relative to the tensioners 324a,b, and locked positions, shown in dotted lines, in which the locks 326a,b restrain motion of the deflection surface relative to the tensioners 324a,b. The locks 326a,b may be configured to move back and forth between the unlocked positions and the locked positions based on commands, for example, from a controller. In the example shown in FIG. 3C, actuation of the locks 326a,b has a clamp-like effect, compressing respective portions of the deflection surface (e.g., the strap 318b or the cable 322b) against the spool or pulley portions of the tensioners 324a,b, arresting any winding or unwinding of the deflection surface.

Actuation of the locks 326a,b may be concurrent, staggered by side of the seat pan 304, reversible, or irreversible. In reversible systems, the locks 326a,b can include electromechanical components such as actuators, pistons, clamps, cams, or other components sufficient to reversibly hold a position of the deflection surface (e.g., the strap 318b or the cable 322b) relative to the tensioners 324a,b. In other embodiments, actuation of the locks 326a,b may be irreversible, that is, moving from the unlocked position to the locked position may occur only once. In irreversible systems, the locks 326a,b can include mechanical components such as a mechanical lock that engages above a predetermined acceleration threshold or pyrotechnic components such as a pretensioner that fires in response to sensor information indicative of a vehicle event to irreversibly restrain motion of the deflection surface in the locked position. In some examples, actuation of the locks 326a,b can be staggered, that is, the lock 326a may be controlled to move from the unlocked position to the locked position before the locks 326b is controlled to move from the unlocked position to the locked position.

In operation of the positioning system 316 shown in FIGS. 3A to 3C, a controller (not shown) can receive information indicative of a vehicle event, such as an imminent collision, anti-lock braking, or rapid deceleration. The information can be received from various sensors (not shown) that communicate information to the controller such as the sensors described in respect to FIGS. 2A to 2C. The controller can send a command, for example, to the locks 326a,b, that causes the locks 326a,b to restrict motion of the deflection surface (e.g., the strap 318b or the cable 322b) based on the information indicative of the vehicle event. The command sent to the locks 326a,b may cause the lock 326a,b to move from the unlocked positions shown in solid lines in FIG. 3C to the locked positions shown in dotted lines in FIG. 3C. In cases where the locks 326a,b are caused to move from the unlocked position to the locked position based on the information indicative of the vehicle event, the locks 326a,b may also be caused to move from the locked position to the unlocked position based on additional information, e.g., from the sensors, indicative of completion of the vehicle event, such as vehicle deceleration returning below a predetermined deceleration threshold.

In some embodiments, the controller may receive information indicative of a recline angle of a seat including the seat pan 304 being above a recline threshold, such as above a 45, 60, or 75 degree threshold. The controller can send a command, for example, to the locks 326a,b, that causes the locks 326a,b to restrict motion of the deflection surface (e.g., the strap 318b or the cable 322b) based on the information indicative of the recline angle being above the recline threshold. In cases where the locks 326a,b are caused to move from the unlocked position to the locked position based on the information indicative of the recline angle of the seat including the seat pan 304 being above the recline threshold, the locks 326a,b may also be caused to move from the locked position to the unlocked position based on additional information, e.g., from the sensors, indicative of the recline angle of the seat including the seat pan 304 moving below the recline threshold, such as below 45, 60, or 75 degrees.

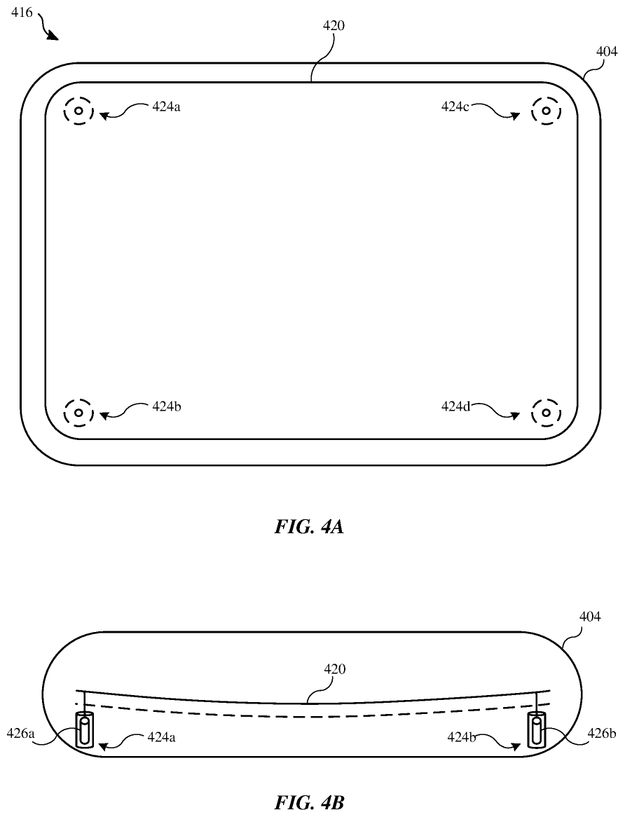

FIGS. 4A and 4B show examples of another positioning system 416 for use with the seat 100 of FIGS. 1A and 1B. The positioning system 416 is shown as disposed within a seat pan 404 similar to the seat pans 104, 204, 304 of FIGS. 1A to 3C. In FIG. 4A, the seat pan 404 is shown from a top sectional or cutaway view. In FIG. 4B, the seat pan 404 is shown from a front sectional or cutaway view.

The positioning system 416 includes a deflection surface disposed within the seat pan 404 that is configured to support an occupant in the seat, that is, on the seat pan 404. The deflection surface includes a panel 420. The panel 420 in the example of FIGS. 4A and 4B is generally rigid. For example, the panel 420 may be formed by materials such as steel, aluminum, alloy, composite, or other rigid materials. The panel 420, though generally rigid, may be designed for deformability above a predetermined load threshold. This deformability may be provided by perforations, holes, etc. (not shown) that modify elongation and lower yield properties. The panel 420 may be positioned within the seat pan 404 in a manner that aligns with weight distributions of 5^{th} to 95^{th} percentile sizes of seated occupants. As shown in FIG. 4B, the panel 420 is positioned within a central portion or lower half of the seat pan 404 in the up-down or Z-direction, such as in a space or gap present between foam (not shown) present in a top half of the seat pan 404 and a spring-based seat suspension (not shown) present in a bottom half of the seat pan 404.

The positioning system 416 includes tensioners 424a,b,c,d configured to control motion of the panel 420 with respect to the seat pan 404. For example, each of the tensioners 424a,b,c,d may include a compressible portion, such as a spring or a pneumatic device. The spring may be configured to deform above a predetermined load threshold to control an up-down or Z-direction position of the panel 420. The spring may include pre-tensioned portions configured to be held in tension until being selectively released, for example, based on a command from the controller. A travel distance for the panel 420 may be over 5 mm, over 20 mm, over 35 mm, or over 50 mm. The pneumatic device may include pressurized gas (or a vacuum) configured to effect movement of a piston (not shown) based on a command from a controller (not shown). The tensioners 424a,b,c,d may be tuned, for example, to occupant mass, where heavier occupants may require more tension control than lighter occupants. Though four tensioners 424a,b,c,d are shown, one per corner of the panel 420, additional or fewer are possible.

As shown in FIG. 4B, the positioning system 416 includes at least two locks 426a,b. The locks 426a,b may be part of or coupled to the respective tensioners 424a,b as shown. The locks 426a,b may be configured to restrict deformation or extension of a compressible portion, such as a spring or a pneumatic device (not shown) that is part of the respective tensioners 424a,b. In an unlocked position of the locks 426a,b, the panel 420, which is supported by the compressible portions of the tensioners 424a,b, is free to move up and down in the Z direction such as shown in dashed line at a lowermost position. In a locked position of the locks 426a,b, the panel 420 is blocked from movement relative to the tensioners 424a,b, such as shown in solid line at an uppermost position for the panel 420. The locks 426a,b may be configured to move back and forth between the unlocked positions and the locked positions based on commands, for example, from a controller. Though two locks 426a,b are shown, additional locks, such as associated with the tensioners 424c,d, are also possible.

Actuation of the locks 426a,b may be concurrent, staggered, reversible, or irreversible. For example, actuation of the locks 426a,b shown in FIG. 4B at a front of the seat pan 404 may occur at a same time (i.e., concurrent actuation), but before actuation of locks (not shown) at a rear of the seat pan 404 (i.e., staggered actuation). Actuation of the locks 426a,b may be relatively unobtrusive to the seated occupant, especially in the case of the panel 420 that is positioned centrally or in a bottom half of the seat pan 404, since foam layers (not shown) may be positioned between the seated occupant (not shown) and the panel 420.

In operation of the positioning system 416 shown in FIGS. 4A and 4B, a controller (not shown) can receive information indicative of a vehicle event, such as an imminent collision, anti-lock braking, or rapid deceleration. The information can be received from various sensors (not shown) that communicate information to the controller such as the sensors described in respect to FIGS. 2A to 2C. The controller can send a command, for example, to the locks 426a,b, that causes the locks 426a,b to restrict motion of the panel 420 based on the information indicative of the vehicle event. The command sent to the locks 426a,b may also cause the tensioners 424a,b to move the panel 420 from the position shown in dashed line to the position shown in solid line in FIG. 4B. The panel 420 may held in the solid line position by the locks 426a,b until an end of the vehicle event, such as when vehicle deceleration returns below a predetermined deceleration threshold or anti-lock braking completes.

In some embodiments, the controller may receive information indicative of a recline angle of a seat including the seat pan 404 being above a recline threshold, such as above a 45, 60, or 75 degree threshold. The controller can send a command, for example, to the tensioners 424a,b or the locks 426a,b, that causes the panel 420 to be held in the position shown in solid line in FIG. 4B based on the information indicative of the recline angle being above the recline threshold. Additional information, e.g., from the sensors, indicative of the recline angle of the seat including the seat pan 404 moving below the recline threshold may cause the locks 426a,b, to release or move to an unlocked position such that the panel 420 is again movable with respect to the tensioners 424a,b.

In the examples described in respect to FIGS. 2A to 4B, the tensioners 224, 324a,b, 424a,b,c,d and the locks 226, 326a,b, 426a,b may include an electromechanical device, a pyrotechnic device, a pneumatic device, a pre-tensioned spring, or combinations thereof. Electromechanical devices may include spools, pulleys, springs (e.g., uncompressed or extended), electric motors, threaded rods, threaded guides, or combinations thereof that may be coupled to a sensor that receives commands from a controller. Pyrotechnic devices may include an electronically activated pyrotechnic charge which releases a blocking apparatus or severs a restraining device. Pneumatic devices may include pressurized gas (or a vacuum) configured to effect movement of a piston based on a command. Pre-tensioned springs may include a spring that is coupled to a sensor. The spring can be held in tension until being selectively released, for example, based on a command from the controller. The tensioners 224a,b, 324a,b, 424a,b,c,d and the locks 226, 326a,b, 426a,b can also include other mechanisms such as magnetic systems, telescoping systems, cable or tether systems, etc.

In the examples described in respect to FIGS. 2A to 4B, the straps 218a,b, 318a,b,c, the panels 220, 320, 420, the cables 222a,b, 322a,b, the tensioners 224, 324a,b, 424a,b,c,d, or the locks 226, 326a,b, 426a,b may include load limiting features that allow deformation, movement, or stretch of the deflection surface above a predetermined load threshold during various vehicle events. Load limiting features can be implemented, for example, after other safety systems, such as lap restraints or airbags, have been engaged or deployed to further restrain the occupant during the vehicle event. Load limiting features may be implemented using torsion bars, metals with specified yield or bending limits, locking tubes with deformation, electric motors that are back drivable, etc. In a case of flexible materials, such as for the straps 218a,b, 318a,b, elongation properties may be tuned for yield or extension based on a size or a mass of a seated occupant. In some examples, load limiting features can be selected based on modeling to cover 5^{th} to 95^{th} percentile sizes of seated occupants.

The predetermined load threshold described with respect to engagement or disengagement of the locks 226, 326a,b, 426a,b can be based on or associated with various inputs related to the vehicle or the vehicle event such as a rapid deceleration, anti-lock braking, or likelihood of an imminent collision. For example, the predetermined load threshold can be based on inputs to a controller (not shown) such as vehicle speed, occupant mass, occupant height, occupant position in the seat pan 204, 304, 404, position of a seat back (not shown) in relation to the seat pan 204, 304, 404, type of vehicle event, location of vehicle event, time to vehicle event, etc. The controller can be configured to set or change the predetermined load threshold based on an assessment of occupant features upon the occupant entering or approaching the vehicle, prior to a vehicle event, for example, within hundreds of milliseconds prior to an imminent collision, or after a vehicle event is detected, for example, using a mechanism configured to activate in under 5, 10, or 20 milliseconds.

The positioning systems 216, 316, 416 of FIGS. 2A to 4B can be used in combination with other safety features, such as lap and shoulder belts and air bags, to provide a comprehensive safety solution. For example, the straps 218a,b, 318a,b,c, the panels 220, 320, 420, or the cables 222a,b, 322a,b of FIGS. 2A to 4B may be held taut against an occupant in the seat pan 204, 304, 404 while the lap and shoulder belts are held taut against the occupant in the seat pan 204, 304, 404, thus holding the occupant in a desired position more securely than is possible with the lap and shoulder belts alone. In another example, the straps 218a,b, 318a,b,c, the panels 220, 320, 420, or the cables 222a,b, 322a,b of FIGS. 2A to 4B may be cycled between slack and taut positions, providing haptic feedback to an occupant in the seat pan 204, 304, 404, such as may be beneficial as an alert during handoff from autonomous to manual control of a vehicle including the seat pan 204, 304, 404.

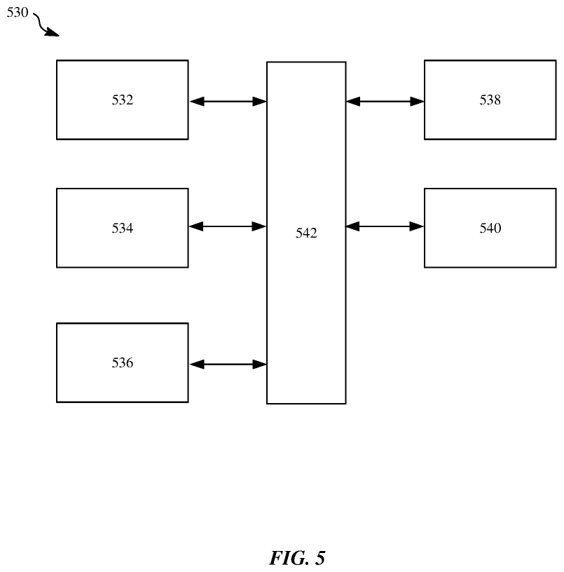

FIG. 5 shows an example of a hardware configuration for a controller 530 that may be used to implement the positioning systems 216, 316, 416 of FIGS. 2A to 4B. In the illustrated example, the controller 530 includes a processor 532, a memory device 534, a storage device 536, an input device 538, and an output device 540. These components may be interconnected by hardware such as a bus 542 that allows communication between the components.

The processor 532 may be a conventional device such as a central processing unit and is operable to execute computer program instructions and perform operations described by the computer program instructions. The memory device 534 may be a volatile, high-speed, short-term information storage device such as a random-access memory module. The storage device 536 may be a non-volatile information storage device such as a hard drive or a solid-state drive. The input device 538 may include sensors or any type of human-machine interface, such as buttons, switches, a keyboard, a mouse, a touchscreen input device, a gestural input device, or an audio input device. The output device 540 may include any type of device operable to send commands associated with an operating mode or state or provide an indication to a user regarding an operating mode or state, such as a display screen, an interface for a positioning system such as the positioning systems 216, 316, 416, or an audio output.

As described above, one aspect of the present technology is the gathering and use of data available from various sources, such as from sensors or user profiles, to improve the function of positioning systems such as the positioning systems 216, 316, 416 of FIGS. 2A to 4B. The present disclosure contemplates that in some instances, this gathered data may include personal information data that uniquely identifies or can be used to contact or locate a specific person. Such personal information data can include demographic data, location-based data, telephone numbers, email addresses, twitter IDs, home addresses, data or records relating to a user's health or level of fitness (e.g., vital signs measurements, medication information, exercise information), date of birth, or any other identifying or personal information.

The present disclosure recognizes that the use of personal information data, in the present technology, can be used to the benefit of users. For example, the personal information data can be used to deliver changes to operational modes of positioning systems to best match user preferences or profiles. Other uses for personal information data that benefit the user are also possible. For instance, health and fitness data may be used to provide insights into a user's general wellness or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users and should be updated as the collection and/or use of data changes. Personal information from users should be collected for legitimate and reasonable uses of the entity and not shared or sold outside of those legitimate uses. Further, such collection/sharing should occur after receiving the informed consent of the users.

Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of user-profile-based positioning systems, the present technology can be configured to allow users to select to “opt in” or “opt out” of participation in the collection of personal information data during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can be implemented without the need for accessing such personal information data. That is, the various embodiments of the present technology are not rendered inoperable due to the lack of all or a portion of such personal information data. For example, changes in operational modes in positioning systems can be implemented for a given user by inferring user preferences or user status based on non-personal information data, a bare minimum amount of personal information, other non-personal information available to the system, or publicly available information.

What is claimed is:

1. A positioning system, comprising:
a deflection surface disposed within a seat, configured to support an occupant in the seat, and movable in response to motion of the occupant; and
a lock movable between an unlocked position in which the lock permits motion of the deflection surface relative to motion of the occupant and a locked position in which the lock restrains motion of the deflection surface relative to motion of the occupant,
wherein the lock is configured to move from the unlocked position to the locked position in response to receiving a signal from a controller, the signal including information indicative of a vehicle event.

2. The positioning system of claim 1, further comprising:
a tensioner coupled to the deflection surface and the seat, the tensioner configured to control motion of the deflection surface with respect to the seat.

3. The positioning system of claim 2, wherein the tensioner comprises a compressible portion configured to deform above a predetermined load threshold.

4. The positioning system of claim 3, wherein the lock is configured to restrict deformation of the compressible portion in the locked position.

5. The positioning system of claim 1, wherein the lock includes a pretensioner configured to irreversibly restrain motion of the deflection surface in the locked position.

6. The positioning system of claim 1, wherein the deflection surface comprises flexible straps.

7. The positioning system of claim 6, wherein the deflection surface further comprises a flexible panel.

8. The positioning system of claim 1, wherein the deflection surface comprises a rigid panel.

9. The positioning system of claim 1, further comprising:
a sleeve disposed within the seat and configured to isolate the deflection surface from other components within the seat, the deflection surface movable within the sleeve.

10. The positioning system of claim 1, wherein the lock is configured to move from the unlocked position to the locked position in response to receiving information indicative of a recline angle of a seat back of the seat relative to a seat pan of the seat being above a recline threshold.

11. The positioning system of claim 10, wherein the lock is configured to move from the locked position to the unlocked position in response to receiving information indicative of the recline angle being below the recline threshold.

12. The positioning system of claim 11, wherein the recline threshold is greater than or equal to 45 degrees.

13. A positioning system, comprising:
a seat including a seat back positioned in relation to a seat pan at a recline angle;
a deflection surface disposed within the seat pan and movable in response to motion of an occupant in the seat;
a tensioner configured to control motion of the deflection surface with respect to the seat pan; and
a lock configured to restrain motion of the deflection surface relative to the tensioner,
wherein the lock is configured to restrict motion of the deflection surface relative to the tensioner based on receipt of information indicative of a vehicle event and based on receipt of information indicative of a recline angle being above a recline threshold.

14. The positioning system of claim 13, wherein the deflection surface comprises a flexible panel.

15. The positioning system of claim 13, wherein the tensioner comprises a retractor and a pulley configured to control tension in the deflection surface.

16. The positioning system of claim 13, wherein the tensioner comprises a spool configured to control tension in the deflection surface.

17. The positioning system of claim 13, wherein the tensioner comprises a compressible portion configured to deform above a predetermined load threshold to control motion of the deflection surface, wherein the lock is configured to restrict deformation of the compressible portion, and wherein the deflection surface comprises a rigid panel supported on the compressible portion.

18. The positioning system of claim 13, further comprising:
an anti-submarining restraint disposed within the seat pan, the tensioner and the lock disposed within the anti-submarining restraint.

19. A method of controlling motion of an occupant in a seat pan, comprising:
receiving, at a controller, information indicative of an imminent vehicle event; and
sending a command, from the controller, to a lock to cause the lock to move from an unlocked position in which the lock permits motion of a deflection surface to a locked position in which the lock restrains motion of the deflection surface based on the information indicative of the imminent vehicle event,
wherein the deflection surface is disposed within a seat pan and supports an occupant in the seat pan.

20. The method of claim 19, wherein the seat pan includes a tensioner coupled to the deflection surface, the tensioner controlling motion of the deflection surface with respect to the seat pan.

21. The method of claim 20, wherein the tensioner comprises a compressible portion deforming above a predetermined load threshold to control motion of the deflection surface.

22. The method of claim 19, further comprising:
receiving, at the controller, information indicative of a recline angle between the seat pan and a seat back being above a recline threshold; and
sending a command, from the controller, to the lock to cause the lock to move from the unlocked position to the locked position based on the information indicative of the recline angle being above the recline threshold.
